(19) United States
(12) Patent Application Publication
(10) Pub. No.: US 2020/0364937 A1
(43) Pub. Date: Nov. 19, 2020

(54) SYSTEM-ADAPTIVE AUGMENTED REALITY

(71) Applicant: Subvrsive, Inc., Austin, TX (US)

(72) Inventor: Christian Selbrede, Austin, TX (US)

(21) Appl. No.: 16/876,806

(22) Filed: May 18, 2020

Related U.S. Application Data
(60) Provisional application No. 62/848,908, filed on May 16, 2019.

(51) Int. Cl. G06T 19/00; G06T 7/70; G06T 7/55; G06T 19/20; G06F 16/587

(52) U.S. Cl. CPC G06T 19/006; G06T 7/70; G06T 7/55; G06T 19/20; H04L 67/42; G06T 2207/30244; G06T 2200/16; G06T 2219/2016; G06T 2210/08; G06F 16/587

(57) ABSTRACT

Provided is a process including obtaining runtime environment properties of a client computing device and selecting a set of software libraries for use by an AR engine based on the runtime environment properties, determining a request including an identifier of an AR content template, and determining a response including a three-dimensional model of the AR content template. The AR engine causes the client computing device to obtain an image of a real-world environment, obtain a virtual representation of the real-world environment by using the set of software libraries, and render the three-dimensional model overlaid on a presentation of the real-world environment on a visual display. The AR engine also can cause the client computing device to detect a change in a pose and update the three-dimensional model on the visual display based on the change in the pose.

### CROSS-REFERENCE TO RELATED APPLICATIONS

This patent claims the benefit of U.S. Provisional Patent Application 62/848,908, filed on May 16, 2019, titled “TOOLING TO BUILD IN-BROWSER AR EXPERIENCES.” The entire content of each aforementioned patent filing is hereby incorporated by reference.

### BACKGROUND

### 1. Field

The present disclosure relates to computer-systems and, more particularly, computer-systems for generating augmented reality content.

### 2. Description of the Related Art

Extended reality (XR) experiences may include virtual reality (VR) and augmented reality (AR) experiences. AR experiences may take a variety of forms. Some AR experiences are presented in customized hardware, like wearable glasses having integrated displays and visual simultaneous localization and mapping capabilities. Other AR experience are presented on mobile computing devices, like tablets and smart phones. AR experiences may engage a relatively diverse set of functionality of the underlying computing hardware, including cameras, displays, inertial measurement units, touchscreens, graphics processing units, central processing units (CPUs), memory, and network interfaces, often with relatively tight frame-rate and latency budgets to present a smooth, realistic experience to the user.

### SUMMARY

The following is a non-exhaustive listing of some embodiments of the present techniques. These and other embodiments are described in the following disclosure.

Some embodiments include a process that includes obtaining, with one or more processors, a set of runtime environment properties of a client computing device. The process may also include selecting, with one or more processors, a set of software libraries of the client computing device for use by an augmented reality (AR) engine based on the set of runtime environment properties, where the AR engine includes a set of binary encodings of a set of bytecode, and where the AR engine is executable within an execution environment of a web browser of the client computing device. The process may also include obtaining, with one or more processors, a request including an identifier of an AR content template and a response including a three-dimensional model of the AR content template. The AR engine, when executed within the execution environment of the web browser, may cause the computing device to obtain an image of a real-world environment from on an image sensor of the client computing device and a virtual representation of the real-world environment by calling functions of the set of software libraries, where the virtual representation includes a depth map of features in the real-world environment, and where the depth map of features includes an anchor position. The AR engine may also cause the computing device to render the three-dimensional model overlaid on a presentation of the real-world environment on a visual display using the AR engine and the virtual representation. The AR engine may also cause the computing device to detect a change in a pose of the image sensor with respect to the anchor position of the virtual representation of the real-world environment, where a position in the virtual representation of the real-world environment of the three-dimensional model is determined based on the anchor position. The AR engine may also cause the computing device to update the three-dimensional model on the visual display using the AR engine and the set of software libraries based on the change in the pose of the image sensor.

Some embodiments include a tangible, non-transitory, machine-readable medium storing instructions that when executed by a data processing apparatus cause the data processing apparatus to perform operations including the above-mentioned process.

Some embodiments include a system, including: one or more processors; and memory storing instructions that when executed by the processors cause the processors to effectuate operations of the above-mentioned process.

### BRIEF DESCRIPTION OF THE DRAWINGS

The above-mentioned embodiments and other embodiments of the present techniques will be better understood when the present application is read in view of the following figures in which like numbers indicate similar or identical elements:

FIG. 1 illustrates an example of a computing environment within which the present techniques may be implemented.

FIG. 2 is a flowchart of a process to provide an environment-responsive augmented reality (AR) platform, in accordance with some embodiments of the present techniques.

FIG. 3 illustrates an example computing system in accordance with the present techniques.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of augmented reality, human-computer interaction, or computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Components of an AR platform, such as an AR content template or an AR engine, may be used to provide an interactive AR experience between a real-world environment and computer-generated perceptual information responsive to changes detected in the real-world environment. However, the widespread use of AR technology may be hindered by cross-compatibility issues facing AR technology across different computing devices and the poor performance of some cross-compatible implementations of AR technology. Challenges to implementing performant cross-compatible AR technology may include differing hardware features, various operating systems, or disparate sets of software libraries across a wide spectrum of computing devices.

The difficulty of providing cross-compatible AR experiences can be amplified in real-world use-cases that may involve more than 100 or more than 1,000 concurrent data sessions with more than 10,000, more than 100,000, or more than 10 million computing devices. This difficulty may further be exacerbated by the substantial computational challenges of providing AR content when considering the limited processing power of some computing devices, such as those of mobile computing devices. Some embodiments may generate AR frames at a rate of more the one per second, such as more than 15 per second or more than 24 per second, with less than 1 second of latency, such as less than 500 milliseconds (ms), or less than 50 ms of latency on images. In some embodiments, the images may include more than 100,000 pixels, than 1 million pixels, more than 2 million pixels, where a three-dimensional (3D) model being rendered may have more than 10, more than 100, more than 1,000, or more than 10,000 triangles in a mesh of the 3D model.

Some embodiments may deliver cross-compatible AR experiences to a computing device by providing program instructions of an AR platform to a native application of the computing device, where the native application may provide web-browsing functionality. The program instructions may cause the computing device to render AR content. Some embodiments may determine properties of a runtime environment of the computing device or adaptively modify operations of the components of the AR platform (e.g., an AR engine, AR content template, or the like) to render AR content based on the properties of the execution environment. In some embodiments, the AR engine may be configured for execution within the execution environment of a web browser or otherwise be executed concurrently with the web browser or other native application to present AR content of an AR content template.

Some embodiments provide or modify an AR content template storing or otherwise associated with data used to present AR content items in a visual display, where a content item may include a two-dimensional (2D) model, 3D model, an image file, a texture, another visual element, or the like. The AR content template may include one or more content items such as 3D models, item properties influencing the behavior of 3D models, or delivery properties that may be used to determine which scenarios AR content may be presented. Some embodiments may include or otherwise use a compiler configured to compile high abstraction level code of an AR content template into WebAssembly code (e.g., code in the “.wasm” format) or some other set of binary encodings of a set of bytecode compatible with an AR engine. In some embodiments, the program instructions of the AR engine may be used concurrently with the program instructions of the AR content template to generate a rendered AR content item of the AR content template. In some embodiments, instead of or in addition to storing or sending binary encodings of a set of bytecode such as a set of operational codes (opcodes) of a stack-based virtual machine (e.g., WebAssembly code), an AR platform server may store or send intermediate bytecode, such as bytecode in the WebAssembly text format (e.g., code in the “.wat” format).

Some embodiments may use the operations described above to present AR content within a set of widely-distributed web browsing applications of a plurality of computing devices having a high degree of fragmentation in software or hardware configuration. By permitting web browsers native to their respective operating systems and computing devices to view AR content, some embodiments may reduce the reliance on custom-built, native AR applications and increase the adoption of AR technology in general-use settings. Furthermore, by relying on the security features of a native web browsing application to restrict malicious or otherwise undesirable software library use or hardware use when delivering AR content, some embodiments may provide AR content without increasing an attack surface of the computing device.

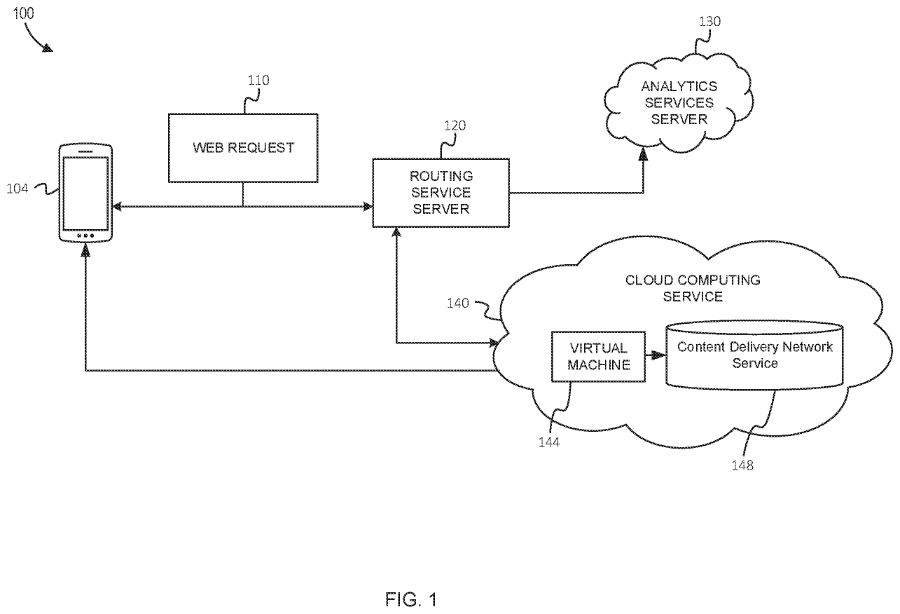

FIG. 1 illustrates an example of a computing environment within which the present techniques may be implemented. In some embodiments, the computing environment 100 may include a plurality of user computing devices and an AR computing platform. The AR computing platform may include a set of servers (“AR platform server”) used to deliver AR content to a computing device 104. The set of AR platform servers may include a routing service server 120, a cloud computing server 140, or an analytics server 150. In some embodiments, the computing device 104, the set of AR platform servers, and related AR services may communicate over a network such as the Internet. In some embodiments, at least a portion of communication over the network may occur via a wireless communication network such as a WiFi wireless network, a 4G or 5G cellular communication, or the like. In some embodiments, some or all of the AR platform servers may be implemented as a collection of services running on various hosts, each executing its own server process, as part of a server-system in a datacenter. Alternatively, some or all these services may be consolidated within one AR platform server or distributed in various other configurations.

As shown in the computing environment 100, a computing device 104 may send a web request 110 to a routing service server 120 of an AR platform. As further discussed below, the web request 110 may indicate that a web browser of the computing device 104 is requesting a resource, such as computer program instructions of an AR engine or content from an AR content template. The computing device 104 may include a mobile telephonic device, tablet, wearable computing device, or the like. While only one computing device is depicted in FIG. 1, some embodiments may concurrently receive and provide data to a plurality of computing devices. In some embodiments, the web request may be directed to the routing service server 120. As further described below, the routing service server 120 may also be used to route data from an AR platform server to the computing device 104.

In some embodiments, the cloud computing server 140 may determine components of an AR platform for the computing device 104 based on the web request 110 using a virtual machine 144. The cloud computing server 140 may then retrieve data associated with the AR platform (e.g., data associated with an AR engine or AR content template) from a content delivery network (CDN) 148. In some embodiments, the data associated with the cloud computing server 140 may include program instructions of an AR engine, where program instructions may include high abstraction level computer program source code, intermediate program bytecode, binary encoding of the intermediate program bytecode, machine level code, or the like. a mesh representing a 3D model, item properties, or the like. In some embodiments, the computing device 104 may also provide a set of runtime environment properties of the runtime environment within which a native application of the computing device 104 may execute. The native application of the computing device 104 may be coded in the machine language of the hardware platform of the computing device 104.

A native application may include a web browser application or other native application having web browser functionality for rendering web content. As used in this disclosure, a web browser may be used to refer to both stand-alone web browsing applications as well as other program applications having web browser functionality (e.g., a webview instantiated in a program application having non-browsing functionalities, such as a videogame). In some embodiments, a web browser or other native application having web browser functionality may be configured to execute or render traditional web content based on data stored in internet-compatible data formats or programming languages such as the hypertext markup language (HTML) or JavaScript™. In some embodiments, the web browser may include a code interpreter capable of interpreting computer program instructions, such as computer program instructions of an AR engine, where the interpreted computer program instructions may be executed in the runtime execution environment of the web browser. In some embodiments, the virtual machine 144 or other components of the cloud computing server 140 may instantiate and execute various operations described in this disclosure. In some embodiments, the cloud computing server 140 may provide an AR engine configured to render AR content within an interface of a native application. Some embodiments may adaptively modify operations of the AR platform (e.g., operations of the AR engine, operations of AR content, or the like) based on properties of the runtime environment of the computing device 104.

The CDN 148 may send the data of an AR engine or an AR content template to the computing device 104 directly, via the routing service server 120, via different routing service, or the like. For example, the routing service server 120 may receive and inspect web traffic such as a request or a response from the CDN 148. In some embodiments, the routing service server 120 may route the traffic based on a universal resource locator (URL) encoded by the request or response. The routing service 120 may then provide data associated with an AR platform or other content from the CDN 148 to the computing device 104.

The CDN 148 may send data to a computing device via a secure protocol or other protocol by which a native application may retrieve online content. For example, the CDN 148 may send content via secure HTTP to a native application like a web browser operating on the computing device 104. The CDN may include a content delivery service, like a Microsoft Azure Content Delivery Network service. In some embodiments, the virtual machine 144 may be executed using a Linux-based operating system and may be used to generate and serve a web page to a web browser of the computing device 104. AR engine program instructions, AR content templates, or other data associated with an AR platform may be hosted by the CDN 148 or other server, such as a third-party CDN. The CDN 148 may also store plurality of AR engines and AR content templates that may be provided to and executed by a client device such as the computing device 104.

In some embodiments, as further discussed below, the AR engine may be executed within an execution environment of a native application operating on the computing device 104 to present AR content within an interface of the native application. For example, the AR engine may be configured to retrieve AR content items from an AR content template that is obtained from the CDN 148 and render those AR content items within an interface of the native application for visualization on a visual display of the computing device 104. In some embodiments, the AR engine provided to the computing device 104 may be adaptively modified by the cloud computing server 140 based on a set of runtime environment properties of the computing device 104. Alternatively, or in addition, the AR engine may include program instructions to cause the mobile computing device 104 to adaptively modify AR operations (e.g., rendering AR content) based on the set of runtime environment properties of the computing device 104. As discussed herein, adaptive modification should not be construed to suggest that every embodiment of the AR platform necessarily be modified or otherwise adapted for every device, or even a specific device, in order constitute an adaptive modification. An adaptive modification may include adjusting a parameter or a set of parameters to increase a performance of an AR engine present within a constraint of a computing device.

In some embodiments, interactions with AR content may be measured and provided to the analytics services server 130. The analytics services server 130 may analyze feedback about AR content provided by the CDN 148 to the computing device 104 or information received from the computing device 104 about interactions with AR content. The analytics services server 130 may determine AR computing platform performance parameters such as content traffic, latency, demographics, or popularity measurements of different AR content items or their associated item properties.

The methods and systems described in this disclosure may enable an AR platform to be cross-compatible with respect to various web browsers native to various operating systems. This cross-compatibility may reduce the reliance on propriety hardware and applications for AR content delivery. This cross-compatibility may also reduce the breakage in user engagement caused by requirements of native applications or other forms of content. The adaptive modification of an AR platform and AR content based on the runtime environment of a computing device may also increase AR engine performance in comparison to other browser-based AR implementations. Furthermore, by using a web browser native to an operating system to present AR content such as rotatable 360-degree views of products, interactive games featuring products, interactive product modification overlaid over a real-world environment, or the like, some embodiments may more easily integrate components of the AR platform with an existing internet infrastructure.

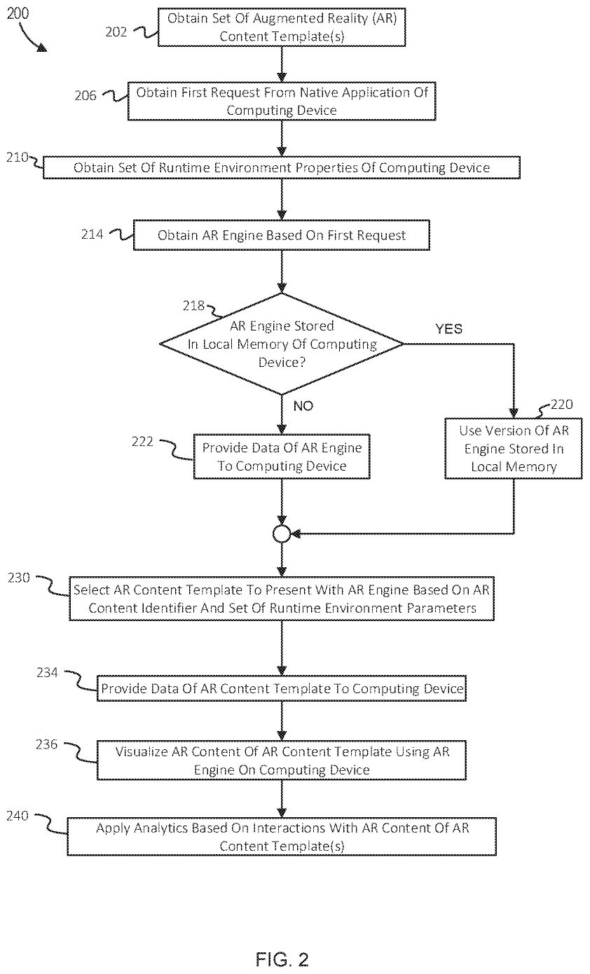

FIG. 2 is a flowchart of a process to provide an environment-responsive augmented reality (AR) platform, in accordance with some embodiments of the present techniques. For example, the process may execute one or more routines in the computing environment 100. In some embodiments, the various operations of the process 200 may be executed in a different order, operations may be omitted, operations may be replicated, additional operations may be included, some operations may be performed concurrently, some operations may be performed sequentially, and multiple instances of the process 200 may be executed concurrently, none of which is to suggest that any other description herein is limited to the arrangement described. In some embodiments, the operations of the process 300 may be effectuated by executing program code stored in one or more instances of a machine-readable non-transitory medium, which in some cases may include storing different subsets of the instructions on different physical embodiments of the medium and executing those different subsets with different processors, an arrangement that is consistent with use of the singular term “medium” herein.

In some embodiments, the process 200 may include obtaining a set of AR content templates, as indicated for block 202. Obtaining the set of AR content templates may include obtaining data of an AR content template or data used to generate an AR content template at a server system, such as a computing system of an AR platform server. In some embodiments, an AR platform server may include an interface for entities to generate AR content templates. For example, an entity may upload an initial multidimensional model (e.g., an initial 3D model) usable as an AR content item. The entity may also upload a set of item properties associated with the multidimensional model, scripted functionality associated with the multidimensional model, or UI elements associated with the multidimensional model. In some embodiments, the initial multidimensional may be used as a multidimensional model of the AR content template. The uploaded data may be combined and used to generate an AR content template. Alternatively, or in addition, some embodiments may use a mesh reduction algorithm to reduce the size of an initial two-dimensional model or an initial three-dimensional model to generate additional models, as further described below. In some embodiments, the uploaded data may be stored in a record of an AR content template. Alternatively, or in addition, some embodiments may generate a record of an AR content template based on the uploaded data.

In some embodiments, an AR content template may include a set of content items, item properties, and delivery properties. Some embodiments may use an item property to determine an item appearance. In some embodiments, item properties include a scaling factor for a content item, textures for a content item, content item file size, a content item file format, or the like. In some embodiments, an AR content template may include multiple content items and may further include item properties such as positional information for a content item relative to other ones of the content items. In some embodiments, an item property may be used to determine a response of a model to changes in a real-world environment.

In some embodiments, obtaining the set of AR content templates may include obtaining a respective set of AR content scripts for each AR content template. An AR content script may encode instructions or a parameter used to determine an AR content item appearance or an amount by which a presentation of the AR content item changes in response to a detected change in the real-world environment. In some embodiments, an AR content script may specify how to apply textures, scale, or otherwise modify the display of an AR content item in response to direct user interactions with the content item or with the virtual environment represented on a visual display of a computing device. For example, an AR content script may determine the visual response of a rendered AR content item after a user presses on a portion of a computing device screen to select the AR content item. Alternatively, or in addition, an AR content script may specify how to modify the display of an AR content item in response to indirect interactions with the content item or within an environment. For example, an AR content script may specify how to modify a content item such as a virtual flower in response to a relative movement of the computing device displaying the virtual flower pot with respect to an anchor position in a real-world environment.

Some embodiments may use a compiler configured to compile high abstraction level program instructions of an AR content template into low abstraction level program instructions such as a set of opcodes of a stack-based virtual machine (e.g., WebAssembly code) compatible with an AR engine. In some embodiments, as further discussed below, the high abstraction level program instructions or set of opcodes based on the high abstraction level program instructions may be modified for execution within a runtime environment of a computing device. This low abstraction level code may be more efficient for a processor of a computing device to execute. For example, as discussed further below, some embodiments may provide low abstraction level WebAssembly code or other set of binary encodings of a set of bytecode. As discussed above, the use of low abstraction level code may provide greater performance (e.g., faster) in comparison to web browsers that provide AR content by obtaining instructions encoded in a high abstraction level language such as the JavaScript programming language.

Some embodiments may convert AR content stored as a first file format into one or more other file formats. For example, a first file of a 3D model stored as a first type may be converted to one or more other file formats to fill out a set of content items having different file formats for different modifications. Alternatively, or in addition, some embodiments may generate a set of files having a shared file format having different file sizes. For example, some embodiments may down sample an uploaded texture file to generate a set of texture files that includes a first file requiring 100 kilobytes of computer memory, a second file requiring 1 megabyte of computer memory, and a third file requiring 20 megabytes of computer memory. An AR content template may include or otherwise be associated with a plurality of files having a shared file format associated with a single content item, such as a 2D model, 3D model, a texture, or the like. As further discussed below, some embodiments may select a file from the plurality of files of an AR content template for delivery to a computing device from an AR platform server based on a set of runtime environment properties of the computing device.

In some embodiments, the process 200 may include obtaining a first request from a native application of a computing device, as indicated for block indicated in block 206. In some embodiments, a server may obtain the request as a web request for a resource that is sent from a web browser or other native application having web browser functionality operating on a mobile computing device. The web browser may download or run program instructions from various types of sources on the Internet, and may host or otherwise initiate virtual machine operations (e.g., stack-based virtual machine operations). For example, a web browser may include a built-in interpreter to interpret program instructions, such as ECMAscript source code or webAssembly bytecode, for execution within a same runtime execution environment of the web browser or runtime execution environment of the operating system that the web browser is running on. In some embodiments, web browser applications may include Safari®, Chrome™, or the like. In some embodiments, the web browser functionality upon which those web browser applications or other native applications are based may include a browser engine such as WebKit™, Chromium™ or the like. As further discussed below, a web browser or other native application may impose security policies that constrain what downloaded program instructions (e.g., a web page or JavaScript™ therein) can do relative to other types of native applications. For example, a web browser may limit access to computing hardware of a computing device such as an inertial measurement unit (IMU), a graphic processor unit (GPU), or a camera.

The request may indicate that the native application is requesting a resource. In some embodiments, the resource may include AR platform data such as program instructions of an AR engine configured to generate a rendered AR content item within the native application. For example, upon navigating to a URL that contains AR content, HTML may be sent to the browser that includes a link to the AR engine. In some embodiments, the AR platform server may receive a set of cookie values determined on the computing device in association with the first request, such as in the same first request or in a second request associated with the first request. The set of cookie values may be received from the computing device or another server hosting a webpage associated with AR content, and may indicate or be used to determine a set of properties of the runtime environment of the computing device.

In some embodiments, the process 200 may include obtaining a set of runtime environment parameters of the computing device, as indicated in block 210. In some embodiments, the set of runtime environment properties may be obtained from a web browser or other native application executing program instructions of a web document. In some embodiments, a native application may obtain the runtime environment properties using a set of cookie values, a beacon injected in web content, or the like. For example, a webpage presented by a native application having web browser functionality may include web code containing a beacon, like a pixel beacon. The beacon may encode or otherwise be associated with ECMAScript (e.g., JavaScript) or JSON code injected in the web code of the webpage. For example, the beacon may be configured to obtain properties of the runtime environment of the computing device and set one or more cookie values or send one or more properties of the runtime environment of the computing device to an AR platform server. Alternatively, or in addition, an AR platform server may provide a response to a request that includes a beacon or otherwise a request for cookie values to obtain runtime environment properties of the computing device.

In some embodiments, a runtime environment property may be directly obtained by the native application or another operation executing on the computing device without the use of a cookie, beacon, or the like. For example, the web browser or a different application may provide values indicating a runtime environment property to an AR platform server. Alternatively, or in addition, some embodiments may provide the runtime environment properties directly to a web browser for use by components of an AR platform within the execution environment of the web browser without sending a runtime environment property to an AR platform server. For example, the program instructions an AR engine executing within a web browser may include program instructions to obtain a set of runtime environment properties such as an amount of available memory by performing on an operation to request runtime environment information an API of the operating system.

In some embodiments, runtime environment properties of a computing device may include a set of software environment properties. Software environment properties may indicate the availability, configuration, capability, status, or other property of software-related assets such as a web browser type, a set of available software libraries, an operating system, a model number of the computing device, network connection type, and other information relative to runtime environment of the native application on the computing device. For example, a software environment property may indicate that a web browser is operating on an iOS operating system and has access to a webGL software library. A software library may include a collection of program classes or corresponding methods (which is used interchangeably with the term “function” in this disclosure) that may define a set of computer-executable operations. In some embodiments, obtaining the set of software environment properties for a device may include determining the settings or other configuration parameters of a widely-distributed, stack-based virtual machine run in-browser.

In some embodiments, a stack-based virtual machine may include a real time interpreter of computer program instructions for execution by one or more processors. The stack-based virtual machine may include two data structures: a set of code listing having an instruction pointer and a data stack having a stack pointer. The instruction pointer may indicate which program instructions of the code list to execute and the stack pointer may provide access to the data stack and point to the data stack head. In some embodiments, the set of bytecode of the AR engine or a set of binary encodings of the set of bytecode of the AR engine may provide entries to the code list or data stack of a virtual machine, where the virtual machine may be executed within the execution environment of a web browser.

In some embodiments, determining a set of software environment properties may include determining the presence of a software framework that contains the set of libraries. In some embodiments, using or accessing a software library may include using a software framework that causes a computer system to use a function of the software library. As used in this disclosure, the use of the term “set of libraries” may include a software framework or part of a software framework.

In some embodiments, a runtime environment property may include a hardware environment property of the runtime environment. Hardware environment properties of a computing device may include properties indicating the presence, position, or capability of physical components (e.g., sensors, hardware computing resources, or the like) of a computing device or software libraries associated with the use of the physical components. For example, a hardware environment property of the runtime environment may include an amount of random access memory (RAM) available to one or more of the processing units of a computing device such as a total amount of memory, a reserved amount of memory, or an amount of memory in active use. For example, a hardware environment property having the field title “has_camera_array” may be set to “true” to indicate the presence of a set of image sensors (e.g., cameras, luminescence detectors, or the like). In some embodiments, a hardware environment property may indicate a position of a set of sensors, such as whether a set of cameras is rear-facing or front-facing with respect to a visual display of a mobile computing device. While properties may be categorized in this disclosure, property categories are not mutually exclusive, and a property may be labeled as different types without contradiction. For example, a runtime environment property may be both a hardware environment property and a software environment property unless explicitly stated.

As discussed above, hardware environment properties may include sensor properties indicating the presence, position, or configuration(s) of one or more types of available sensors. Sensor properties may include a presence and position of a camera, an infrared image sensor, a visible spectrum sensor, or an array thereof, such as an array of dual visible spectrum sensors, an array including infrared and visible spectrum sensors, or the like. In some embodiments, the cameras may include depth cameras capable of stereo vision, three or more cameras usable for computational photography calculations, a time-of-flight sensor, a structured light projector with an associated camera, or the like. Hardware environment properties may also include properties indicating the presence of libraries that include functions to provide outputs based on inputs from a set of sensors, such as a software library to determine a depth of a detected object based on the output of a camera array. Some embodiments may obtain hardware environment properties indicating the type and presence of other sensors. Example sensors may include a movement sensor such as an accelerometer or a gyroscopic sensor such as a vibration sensor, a vibration generator, or the like.

Some embodiments may obtain hardware environment properties that include information about the presence, type, capabilities, or status of a hardware acceleration component. A hardware acceleration component may include a processor or co-processor configured to implement hardware acceleration, and may include an application-specific integrated circuit (ASIC) or a field-programmable gate array (FPGA). For example, some embodiments may obtain hardware environment properties indicating that a computing device includes an ASIC such as a Google Edge tensor processing unit (TPU), another hardware acceleration component such as a graphics processor unit (GPU), or the like. In some embodiments, a hardware acceleration component may be used in a graphics processing pipeline for rendering, shading, vector computations, or the like. In some embodiments, a hardware acceleration component such as the Edge TPU of a computing device may cooperate with a physically separate or integrated central processing unit of the computing device to analyze camera and IMU outputs to perform AR operations, such as pose detection, image recognition operation, machine learning operation, or the like.

In some embodiments, runtime environment properties may indicate the presence or capabilities of software libraries using a hardware acceleration component to process learning algorithms. In some embodiments, a hardware acceleration component may include a chip having a relatively large number (e.g., more than 500) of concurrently operating arithmetic logic units (ALUs). In some embodiments, the ALUs may be configured to operate on data expressed in values of less than or equal to 16 bits, 8 bits, or 4 bits to increase parallel computing units per unit area. In some embodiments, a co-processor of a computing device may have an independent memory interface to computer memory relative to a CPU of the computing device. In some embodiments, a co-processor of a computing device may have an independent computer memory from the computer memory accessed by the CPU. In some embodiments, a memory interface of a hardware acceleration component may provide access to a High Bandwidth Memory (HBM), such as memory that includes a 3-dimensional stack of dynamic random access memory or is otherwise specified by the JEDEC HBM2 specification.

In some embodiments, a runtime environment property may be determined based on other runtime environment properties such as an operating system version, a computing device model number, or the like. For example, the runtime environment properties may include a processing unit type or model that may be used to determine other runtime environment properties such as a number of cores, a processor operating frequency, an amount of cache memory, or the like. In some embodiments, a first runtime environment property may be determined by cross-referencing a second runtime environment property (e.g., a hardware component model identifier) with a database to determine the first runtime environment property.

In some embodiments, the runtime environment properties may indicate a connection property such as bandwidth, another measurement of connection speed, a connection type, or the like. For example, some embodiments may obtain a set of runtime environment properties that include an indication of bandwidth, which may then be compared to a bandwidth threshold. As further discussed below, the satisfaction of a connection property threshold such as a bandwidth threshold may change a constraint on an operation of an AR platform.

In some embodiments, the process 200 may include obtaining an AR engine based on the first request, as indicated in block 214. Some embodiments may an AR server system to determine or adaptively modify an AR engine or other components of an AR platform based on properties of a runtime environment of a computing device before sending the AR engine or other components of the AR platform to the computing device. Alternatively, or in addition, some embodiments may include an AR server system that obtains a pre-determined AR engine from a server system computer memory. The AR server system may then send the pre-determined AR engine or other pre-determined components of an AR platform to a computing device. The pre-determined AR engine may include program instructions that, when executed, adaptively modify its AR-related operations for presenting AR content based on the set of runtime environment properties while being executed within the execution environment of a web browser or another execution environment of the computing device on which the web browser operates.

In some embodiments, a set of runtime environment properties may be correlated with or otherwise indicative of one or more constraints on computing resource use. In some embodiments, constraints may include a processing power constraint of a central or graphical processing unit, a memory consumption constraint on the amount of memory that can be allocated, a network bandwidth constraint on an available bandwidth during a download of AR content, or the like. In some embodiments, runtime environment properties or their associated constraints may differ between uses of an AR platform on the same device. For example, during a first execution of the program instructions of an AR engine on a computing device, the amount of available RAM may be 5 gigabytes, whereas the amount of available RAM may be 3 gigabytes during a second execution of the program instructions of the AR engine on the same computing device. As further discussed below, the constraints may be used by an AR engine to increase performance when presenting AR content.

In some embodiments, the AR engine may be configured to adaptively modify AR engine operations based on runtime environment properties. For example, some embodiments may obtain a first set of runtime environment properties for a first device and obtain a second set of runtime environment properties for a second device. The first and second set of runtime environment properties may be used to determine that the first device has a greater amount of RAM available for use than the second device. The AR engine may include program instructions that cause the first device to load and retain more data relative to the second device. For example, some embodiments may compare the amount of memory of the first device or second device to a memory use threshold to determine whether a greater or lesser memory consumption constraint should be used. In response to a determination that the amount of memory of the first device satisfies the memory use threshold, some embodiments may cause the first device to use a first memory consumption constraint that allows the first device to allocate a maximum of 4 GB of memory for use by an AR engine. In response to a determination that the amount of memory of the second device does not satisfy the memory use threshold, some embodiments may cause the second device to use a second memory consumption constraint that allows the second device to allocate a maximum of 10 GB of memory for use by an AR engine.

Alternatively, or in addition, some embodiments may modify an AR engine to use a specified constraint based on the set of runtime environment properties of a computing device before sending the AR engine to the computing device. For example, an AR platform server may determine that the set of runtime environment properties of a mobile computing device indicates that the amount of memory of the first device satisfies the memory use threshold. In response, the AR platform server may compile or otherwise generate a set of program instructions of an AR engine that causes the mobile computing device to limit memory allocation by the AR engine to a memory use constraint corresponding to the memory use threshold, such as 10 GB. The AR platform server may then send the compiled version of the AR engine to the mobile computing device.

In some embodiments, the program instructions of the AR engine may include instructions to modify AR engine operations based on runtime environment properties indicating the presence of a specific software library or a specific type of software library. For example, some embodiments may determine that a runtime environment property indicates that a native software library (e.g., Quick Look) of a computing device provides functionality to track device position with 6 degrees of freedom (DOF). In response, the AR engine may include program instructions to use each of the six degrees of freedom measured by a computing device when generating AR content for display on the computing device. Alternatively, a different instance of the same AR engine may include program instructions to use only three degrees of freedom measured by a computing device when generating AR content for display on a second computing device based on a determination that the second device not have access to a software library allowing 6 DOF tracking. Furthermore, some embodiments may use software libraries to track four or more degrees of freedom, such as five degrees of freedom. By including libraries to track a number of DOF other than three or six, some embodiments may accommodate hardware changes (e.g., hardware malfunction) that may restrict or expand the dimensionality of a pose (e.g., a position, an orientation, a position and orientation, or the like) measurable by a computing device.

Alternatively, or in addition, some embodiments may modify an AR engine to use a specified software library or software library type based on the set of runtime environment properties of a computing device before sending the AR engine to the computing device. For example, an AR platform server may determine that the set of runtime environment properties indicates that a mobile computing device is configured to perform 6 DOF tracking. In response, the AR platform server may compile or otherwise generate a set of program instructions of an AR engine that causes the mobile computing device to perform 6 DOF tracking when executed within an execution environment of the mobile computing device. The AR platform server may then send the program instructions to the mobile computing device.

In some embodiments, the program instructions of the AR engine may include instructions to modify AR engine operations to use specific file formats. For example, some embodiments may be configured to process a selected file format of 3D models from amongst a plurality of other files formats for 3D models. The selection of a file format may be based on a runtime environment property of the computing device, like a browser type, operating system, available set of software libraries, etc. Alternatively, or in addition, an AR server may send a modified AR engine to use a specific file type based on a runtime environment property.

In some embodiments, the AR engine may include program instructions stored on a plurality of abstraction layers. For example, the AR engine may have an architecture that includes a first abstraction level web content layer that rests on top of a second abstraction level layer that handles lower-level rendering tasks for 3D objects. In some embodiments, the second abstraction level layer may include or otherwise have access to software libraries such as Three.js or WebXR and may include an application programming interface (API) for accessing software libraries. In some embodiments, the second abstraction level layer may access a set of software libraries for rendering 3D objects. The set of software libraries may include but are not limited to glTF, WebGL, OpenXR, Vulkan OpenGL ES, or the like. For example, the AR engine may include or use a web framework such as A-frame, where content authored in A-Frame may rest on top of a Three.js layer, which may handle lower-level tasks like rendering 3D objects via WebGL.

As further described below, the data associated with the AR platform may include an executable AR engine including computer program instruction in a set of low abstraction level program instructions such as a set of bytecode of the AR engine or a set of binary encodings of the set of bytecode of the AR engine. For example, the low abstraction level program instructions of the AR engine may be at a lower abstraction level than the first abstraction level web content layer associated with the AR engine. In some embodiments, the higher abstraction level program instructions described above may be compiled or otherwise converted into the set of low abstraction level program instructions. A set of low abstraction level program instructions such as WebAssembly code may provide greater performance efficiency when executed within a runtime environment of a computing device in comparison to the high abstraction level program instructions. In some embodiments, the AR engine may include associated information like a hash, signature, or other verifiable cryptographic value by which the authenticity of the AR engine may be verified and conferred to the AR engine. In some embodiments, the AR engine may also include higher abstraction level program instructions such as ECMAScript (e.g., JavaScript).

In some embodiments, the AR engine or other component of an AR platform may be configured to request a set of permissions to access a set of restricted components of a computing device based on a set of runtime environment properties. The set of restricted components may include a hardware component such as a sensor, a hardware acceleration chip, a computer memory, or the like. Alternatively, or in addition, a set of components may include software components, such as specific libraries tor types of libraries. Due to the fragmented nature of computing devices, a component or component type may be restricted for one computing device while not being restricted for the other computing device. For example, while a first computing device may set a camera as restricted and require that an AR engine obtain permission before use, a second computing device may set its respective camera as not restricted and may allow an AR engine to use its respective camera without permission.

In some embodiments, the AR engine may use a pre-launch script to obtain a set of permissions to use a set of restricted components. For example, the set of permissions may be requested via a pre-launch script encoded in the components of an AR platform after an occurrence of an interaction with a user interface (UI) element that indicates that AR content has been requested. In some embodiments, the pre-launch script may be configured to request one or more permissions via an interface of a native application to access a lower level of execution within a runtime environment of a computing device based on a set of runtime environment properties. For example, the pre-launch script may include a set of program instructions configured to cause the native application to request a set of permissions to use a set of hardware components, where the set of hardware components may include a camera array and a hardware acceleration component. In some embodiments, the pre-launch script may include signed web code, like trusted web code, verifiable by the native application and configured to request permissions which may be conferred to an executable body of computer program instructions such as an AR engine.

Alternatively, or additionally, some embodiments may modify a pre-launch script of an AR engine based on a set of runtime environment properties before sending the AR engine to a computing device for execution. For example, an AR platform server may determine that the set of runtime environment properties indicates that a mobile computing device includes a light detection and range (LIDAR) sensor. In response, the AR platform server may modify a pre-launch script of an AR engine. When executed within an execution environment of the mobile computing device, the pre-launch script may cause the mobile computing device to receive a request to permit the AR engine or the native application within which the AR engine is executing to access the sensor output of the LIDAR sensor. The AR platform server may then send the AR engine having the modified pre-launch script to the mobile computing device.

In some embodiments, the permissions may enable an AR engine or other components of an AR platform to more efficiently render AR content by providing a lower level of access within a runtime environment than what some web code may require. For example, the program instructions of the AR engine may encode a set of functions specific to the sensors of a computing device or otherwise capable of using a set of software libraries associated with the sensors, which may include image sensors or movement sensors of the computing device. Such functions may be configured to selectively process data output from one or more types of sensors or their corresponding software libraries based on their presence and position.

As described above, the program instructions of an AR engine may include functions specific performing operations based on the output of a set of sensors, where the AR engine may be required to obtain permission before being able to use some of the set sensors. The set of sensors may include an infrared image sensor, visible spectrum sensor, depth sensitive image sensors, or an array thereof (e.g., dual visible spectrum sensors, infrared and visible spectrum sensors, etc.). In some embodiments, the set of sensors may include a movement sensor such as an accelerometer. In some embodiments, the set of sensors may include a gyroscopic sensor such as a three-axis or six-axis inertial measurement sensor, a vibration sensor, vibration generators, or the like. In some embodiments, the AR engine may use the set of sensors and their associated software libraries to perform one or more operations. For example, an AR engine may include program instructions to determine that a computing device includes a six-axis gyroscopic sensor, an array of cameras, and a set of software libraries for the gyroscopic sensor and the array of cameras based on a set of runtime environment properties. As further discussed below, the program instructions of AR engine may then cause the mobile computing device to use the respective software libraries to determine a pose vector based on data provided by the six-axis gyroscopic sensor and generate a virtual representation of a real-world environment based on images acquired from the array of cameras. In some embodiments, the virtual representation may include a depth map of features representing detected features in the real-world environment, where the depth map of features may include coordinates representing positions of real-world environment features or other points that indicate a distance of the respective positions from the mobile computing device. The virtual representation may also include other information about the real-world environment, such as the location(s) or dimension(s) of a set of objects in the real-world environment, the dimensions of a room in the real-world environment, or the like.

As discussed above, the program instructions of an AR engine may include a set of functions to access or otherwise use a set of hardware acceleration components, such as by a GPU, Edge TPU or the like to increase computational performance when displaying AR content. For example, an AR the hardware acceleration components may be tapped in a graphics processing pipeline. The use of such hardware acceleration components may decrease processing times or increase bandwidth in a rendering pipeline. Furthermore, as described above, some embodiments may obtain properties indicating the presence of a hardware acceleration chip that cooperates with a physically separate or integrated processing unit for analyzing camera and IMU outputs. In response, some embodiments may include operations to use the processing unit to more efficiently determine a pose, the presence of an object, or the like. For example, some embodiments may include program instructions to determine that a set of concurrently operating ALUs are available based on a runtime environment property. An AR engine may then use the concurrently operating ALUs to perform image recognition operations when displaying a three-dimensional model to be overlaid over a real-world environment.

In some embodiments, the process 200 may include determining whether the AR engine is stored in a local memory of computing device, as indicated by block 218. In some embodiments, a determination that the AR engine is stored in a local memory of the computing device may be made based on a determination that a set of program instructions of the AR engine is stored in a local memory, such as in a browser cache of a web browser. For example, a web browser of a computing device may query a browser cache or other local memory of the computing device to determine if the cache or other local memory is storing a WebAssembly version of the AR engine.

Some embodiments may determine that a browser cache stores a version of the AR engine's program instruction and that the version of the program instructions satisfies an engine expiration time criterion. For example, some embodiments may determine a first hash value of a first set of bytecode of an AR engine determined above or a first hash value of a first set of binary encodings of the first set of bytecode and determine a second hash value of a second set of bytecode of an AR engine stored in a browser cache or a second hash value of a second set of binary encodings of the second set of bytecode. In response to a determination that the sets of bytecode (or their corresponding sets of binary encodings) are identical based on a comparison between the first hash value and the second hash value, some embodiments may then determine whether the second set of bytecode is unexpired based on a timestamp associated with the second set bytecode, and thus satisfies the engine expiration time criterion. Some embodiments may then determine that the AR engine is stored in a local memory of the computing device based on a determination that the engine expiration time criterion is satisfied and cause the computing device to use the bytecode version stored in the local memory of the computing device. If a determination is made that the AR engine is stored in a local memory of the computing device, operations of the process 200 may proceed to block 220. Otherwise, operations of the process 200 may proceed to block 222.

In some embodiments, the process 200 may include using a version of the AR engine stored in the local memory, as indicated by block 220. As described above, some embodiments use the version of the AR engine stored in the local memory of the computing device instead of downloading a version of the AR engine. By using the local version of the AR engine stored in cache memory, some embodiments may reduce bandwidth use of the computing device.

Furthermore, by reducing the amount of data to be downloaded, some embodiments may reduce the time required for a computing device to begin presenting AR content compared to computing devices that do not have a cache storing a local version of the AR engine.

In some embodiments, the process 200 may include providing data associated with the AR engine to the computing device, as indicated by block 222. In some embodiments, data associated with the AR engine, such as a bytecode version of the AR engine, may be downloaded by a computing device. In some embodiments, the data of the AR engine may be obtained from a URL reference encoded in the HTML or related scripting of a web page presented by a web browser on a computing device. For example, a web browser or other application executing on the computing device may obtain a bytecode version of pre-interpreted libraries or frameworks of an AR engine provided by an AR platform server, compile that bytecode to executable binary encoding of the bytecode, and store the binary encoding (or its corresponding bytecode) in browser cache. Alternatively, or in addition, an AR server may obtain a binary encoding directly. Alternatively, or in addition, an AR server may provide source code (e.g., JavaScript source code) of the AR engine to the web browser, which may then be interpreted and compiled into a binary encoding.

Some embodiments may then reference the uncompiled or compiled version of the AR engine in a subsequent session to reuse the AR engine or other data of an AR platform, as discussed above. Some embodiments may perform operations to copy the data of the AR platform from one portion of a memory address space, such as the memory address space of the browser JavaScript engine to another memory address space for back-up storage or long-term storage. By copying data across different portions of a memory address space, some embodiments may expedite rendering of AR content.

Some embodiments may provide data of AR platform to a web browser or other native application over the same request-response path as the web content that presented an interface to interact with AR content. For example, a web browser may send a request to obtain AR engine data to the same intermediary destination or final destination as that used to host or generate a web page within which the AR engine is to be executed. Furthermore, as discussed above, some embodiments may obtain the computer instructions or other data of the AR engine or AR content templates from a CDN. For example, some embodiments may retrieve a set of computer program instructions of an AR engine via an API call to the CDN and send the computer program instructions to a mobile computing device that sent a request for the AR engine.

In some embodiments, the process 200 may include selecting an AR content template to present with the AR engine based on an AR content identifier and the set of runtime environment properties, as indicated by block 230. In some embodiments, selecting an AR content template for a computing device may include selecting a set of AR content templates stored in a persistent memory of the computing device or a remote server. In some embodiments, AR content templates may include an AR content identifier by which a computing device may use to request a first AR content template of a plurality of AR content templates.

In some embodiments, an AR content identifier may be sent in a request to an AR platform server to obtain data from an AR content template. For example, a web browser of a computing device may visit a webpage that, when interacted with via a UI element, may cause the web browser to send a request including a URL associated with AR engine. Once the AR engine is found in a local memory or obtained from an AR platform server, the AR engine may operate within the execution environment of the web browser to send a request to an AR platform server, where the request may include an AR content identifier. In response, a virtual machine operating on the AR platform server may send a query via an API of a CDN or other data store to interrogate a database of AR content to determine an AR content template. Furthermore, the AR platform server may select specific content of the AR content template to provide a computing device based on the set of runtime environment properties of the computing device.

The AR platform server may select a set of program instructions of the AR content template, such as WebAssembly code of the AR content template, and AR content of the AR content template based on the request sent by the web browser or other data provided by the computing device. Alternatively, or in addition, the AR engine or another component provided to the computing device may determine specific data of the AR content to retrieve from an AR platform server. For example, an AR engine operating on a computing device may determine a specific file format for a 3D model of an AR content template and a maximum file size for a 3D model texture of the AR content template based on the set of runtime environment properties. The AR content identifier may be used to identify a specific set of data of one or more AR content items by file format, file size, or the like. The specific set of data of the AR content template may include 3D model files, textures, WebAssembly code, or the like usable to governs the presentation of model(s) of the AR content template or UI element(s) of the AR content template.

In some embodiments, an AR content template may include or otherwise be associated with versions of models, textures, or other file assets having different file sizes. For example, an AR content template may include a first 3D model of a coffee mug requiring a first amount of computer memory to store and a second 3D model of a coffee cup requiring a second amount of computer memory to store, where the first amount is less than the second amount. Some embodiments may determine that a set of runtime environment properties of a first computing device satisfies a file reduction threshold and, in response, send the first 3D model to the computing device. Some embodiments may determine that a set of runtime environment properties of a second computing device does not satisfy the file reduction threshold and, in response, send the second 3D model to the computing device.

As discussed above, some embodiments may select a file format of a plurality of file formats based on a set of runtime environment properties. For example, an AR content template may include versions of a 3D model stored in different file formats, where a first, second, third, and fourth 3D model file may be stored in the “,glb” file format, “,usdz” file format, “,fbx” file format, the “.obj” file format, respectively. The “,glb” file format may be capable of providing cross-compatibility across different browsers and operating systems and indicate a file format that is a binary code version of the glTF file format, which is a file format capable of supporting animated 3D content. In some embodiments, different versions of a 3D model may be associated with different functionality. For example, some embodiments may provide 3DOF tracking for “.glb” assets while being capable of providing 6 DOF tracking for “.usdz” assets.

For example, some embodiments may select a file of an AR content template having the “usdz” file format based on a determination that a runtime environment property of the computing device indicates that the computing device having an AR Quick Look libraries or similar functionality, which may support the “.usdz” file format. In response to a determination that the runtime environment property indicates that the mobile computing device supports the “.usdz” file format, some embodiments may send a 3D model file having the “.usdz” file format to the computing device. Alternatively, or in addition, some embodiments may send a 3D model file by default if one or more other determinations to send a file having a different file format is not satisfied. For example, some embodiments may send a 3D model file having the “.glb” file format to the computing device in response to a determination that the computing device does not support the “.usdz” file format. In some embodiments, instead of an AR platform server making a determination to select a file format, the program instructions of an AR engine may be used to select a file format based on a set of runtime environment parameters.

Some embodiments may include determining whether a set of delivery properties associated with the AR content template satisfy a set of delivery criteria. For example, satisfying a delivery criterion for an AR content template may determining that the location of a mobile device downloading data associated with the AR content template is within a geofence defined by the set of delivery properties associated with the AR content template. In some embodiments, a computing device may send a request (or set of requests) identifying an AR content template via a wireless transmission that includes a location of the computing device and an AR content identifier. The AR content server may determine a geofence or other geographic boundary based on delivery properties associated with the requested AR content template. For example, the AR content server may determine a quadrilateral geofence based on delivery properties that include four sets of latitude and longitude coordinates. In response to a determination that the computing device location is within a geofence determined based on the delivery properties, the AR content server may determine that data from the AR content template may be sent to the computing device. Alternatively, or in addition, the AR engine may modify a program state of the AR engine or associated program state value to indicate that a model from the AR content template may be rendered by the AR engine in response to a determination that the computing device location is within the geofence. In some embodiments, delivery properties may be used to determine a geofence usable for governing use of the content item and item properties of the content item.

In some embodiments, the process 200 may include providing data of the AR content template to the computing device, as indicated by block 234. In some embodiments, an AR platform server or other AR server system may deliver data of an AR content template selected above to a computing device. The data of the AR content template may include source code (e.g., JavaScript source code or other ECMAScript source code), a set of bytecode or a set of binary encoding of the set of bytecode (e.g., WebAssembly code), 3D models, images, video, or the like. In some embodiments, the AR platform server may provide the data of the AR content template by accessing an AR content template record stored in or otherwise accessible via a CDN. For example, an AR engine executing within an execution environment of a web browser executing on a mobile computing device may access a reference link of the web page visited by the web browser. The reference link may link to binary format data associated with an AR content template, such as a set of binary encodings of bytecode for a 3D model, texture pack for the 3D model, and AR content scripts governing behaviors of the 3D model in response to changes in a real-world environment. Furthermore, some embodiments may mask the reference, which may allow content to appear to be provided from a different domain. For example, a computing device may mask a reference link such that URL of the reference link points to a first data source instead of a second data source, or an AR platform server may mask the source of the data of the AR content template.

In some embodiments, some or all of the data of an AR template may be streamed via a network connection between a computing device and an AR platform server instead of being downloaded to a persistent memory of the computing device. For example, a computing device may stream a set of files having the “.usdz” file format instead of fully downloading the set of files before use in order to reduce the load times required to begin using the set of files to render AR content. Furthermore, some embodiments may determine to stream content based on a determination that a set of runtime environment properties indicate that network connection type satisfies one or more connection thresholds (e.g., greater than a signal strength threshold, signal reliability threshold, network bandwidth threshold, or the like). In some embodiments, the rate of at which a computing device downloads data from an AR platform server may be determined based on a bandwidth of a plurality of bandwidths, where the specified bandwidth may be selected based on a network bandwidth constraint. For example, if a network bandwidth constraint determined from a runtime environment property is equal to 2 gigabits per second, some embodiments may select 1.5 gigabits per second as an operational bandwidth from a plurality of bandwidths that include 100 kilobits per second, 1 megabit per second, and 1.5 gigabits per second.

In some embodiments, the process 200 may include visualizing AR content from the AR content template using the AR engine executing on the computing device, as indicated by block 236. Visualizing AR content from the AR content template may include displaying a set of AR content item such as a 3D model in a 2D visual display or 3D visual display. The AR content template may be presented within a visual output of a computing device's video capture of a real-world environment by a set of image sensors of the computing device. In some embodiments, the AR content may be scaled, posed, and interacted with a light-field of a world-frame of reference. In some embodiments, the 3D model may be rendered within the real-world environment in substantially real-time (e.g., less than one minute of the image sensors capturing the real-world environment).

In some embodiments, the rendered AR content may be overlaid on a camera feed display in relation to some point's position in a pixel space of that display, where the point may be referred to as an anchor position within the real-world environment or a virtual representation thereof. The anchor's position in pixel space may be tracked using methods such as image recognition to govern a rendering of an AR content item, like the size and position of the rendered AR content. If the camera moves relative to the anchor (e.g., by a change in pose, such as an angular change in the camera or translational change of the camera's position in the real-world environment), then the position of the anchor in pixel space may also move. The AR engine may then update the rendered AR content to reflect the relative motion of the anchor. For example, a content item may be scaled smaller or larger to appear as part of the real-world environment and moving with respect to an anchor position of the content item. In some embodiments, if the position of an anchor moves left/right/up/down, such as by the camera moving, the AR content item may be modified to remain in position and orientation relative to the anchor by rendering perspective changes from the viewpoint of the camera. A model or other content may be describe as being overlaid over a display if one or more pixels of the display are replaced by the model.

The computing device may provide AR content by rendering a virtual model within a real-world environment on the visual display of the computing device, where the real-world environment may be captured by an image sensor of the same computing device. The AR engine may cause the computing device to determine a point cloud, perform feature detection based on the point cloud, and detect anchor positions and planes based on a set of detected features, generate the virtual representation of the real-world environment based on the point cloud and detected features, or the like. In some embodiments, the point cloud or virtual representation may include an additional set of positions detected using other sensors, such as LIDAR sensor, time-of-flight sensor, ultrasonic sensor, or the like. In some embodiments, a depth map of features of the virtual representation may include the additional set of positions. The AR engine may cause a computing device to analyze sensor information to generate the virtual representation of the world-space of the real-world environment and determine one or more anchor positions and planes that can be used to tie content items. In some embodiments, an anchor position or planes may be mapped to or otherwise associated with one or more coordinates in a depth map of features of the virtual representation. For example, some embodiments may analyze frames of video across three or six channels based on three-axis IMU data or six-axis IMU data, respectively, and transform the channel data from pixel space coordinates to world-space coordinates stored in a depth map of features or other data structure of a virtual representation. This transformed channel data may include data usable for determining properties of objects in the real-world environment, such as a realistic size of objects, perspective of objects, shading of objects, or the like. Some embodiments may analyze multiple different image sensors in different spectrums (e.g., visible spectrum, infrared spectrum, ultraviolet spectrum, or the like), such as by image recognition, depth of field, or the like. Some embodiments may refine this data based on an analysis of any additional sensor information, such as that of accelerometers or gyroscopic axis sensors. Some embodiments may determine camera pose (e.g., six coordinates of location and orientation with 6 DOF tracking) relative to the detected anchor positions or planes.

Some embodiments may determine planes and anchor positions using a feature detection algorithm such as an edge detection algorithm or corner detection algorithm to detect features in frames of video, where features may include edges, corners, or another region in a pixel space that is visual distinctive from neighboring regions. For example, some embodiments may use a Canny edge detection method or a Sobel edge detection method as described by Dharampal et al. (“Methods of image edge detection: A review.” J Electr Electron Syst 4.2 2015) to detect features, which is hereby incorporated by reference. Some embodiments may use a Kayyali edge detection method as described by Chaturvedi et al. (“A review paper on EDGE detection with comparative analysis of different edge detection approaches”) to detect features, which is hereby incorporated by reference. Some embodiments may use a Harris and Stephens corner detection method or a SUSAN corner detection method as described by Chen et al. (“The Comparison and Application of Corner Detection Algorithms.” Journal of multimedia 4.6 2009) to detect features, which is hereby incorporated by reference. Some embodiments a corner detection method described by Shi and Tomasi as described by Kenney et al. (“An axiomatic approach to corner detection.” 2005 IEEE Computer Society Conference on Computer Vision and Pattern Recognition CVPR′05. Vol. 1. IEEE, 2005) to detect features, which is hereby incorporated by reference. Some embodiments may use a level curve curvature corner detection method, a FAST edge detection method, a Laplacian of Gaussian feature detection method, Difference of Gaussian feature detection method, Determinant of Hessian feature detector method, or various other feature detection methods to detect features.

Some embodiments may receive a frame, detect features using one or more of the methods described above, detect anchor positions based on the features, and compute a camera pose vector therefrom. This process may be repeated for each received frame in a video feed. For example, some embodiments may use a set of visual simultaneous localization and mapping (VSLAM) techniques that produce a pose of the camera and 3D model of the environment within the camera's field of view.

Some embodiments of the computing device may detect features or other elements of a virtual representation of a real-world environment based on depth images, e.g., with a depth sensor camera that indicates for each pixel both intensity and distance, such as with a time-of-flight camera or LIDAR. Some embodiments may determine anchor positions or planes based on the position of features in structured light provided by the computing device or other light source projected onto a scene captured by an image sensor of the computing device. Some embodiments may determine anchor positions or planes based on images captured from different locations on a camera or positions of the camera. For example, some embodiments may determine a depth using computational photography methods based on parallax differences of a feature in two different images from a stereoscope camera and their associated lens focal lengths. Some embodiments may apply similar methods to determine a depth based on light-field information from 3, 4, 5, 6 or more cameras having varying locations on a computing device, such as from an array of cameras arrayed on the back of a mobile computing device.

Some embodiments may render 3D content or provide audio or haptic feedback based on changes with the real-world environment based on the data used to capture elements of a real-world environment, the anchor positions, and detected planes. For example, some embodiments may change a shape and simulated velocity of a polygon mesh model using a physics engine of an AR engine based on a hand motion captured by a camera. Some embodiments may determine a position, orientation, and scale of 3D content in the world-space coordinate system based on the 3D model, a virtual representation of the real-world environment, and a set of vectors, such as a camera pose vector. Some embodiments may determine how to modify pixel values of a video output to depict a 3D model or another content item of an AR content template based on the position, orientation, scale, or other item property of the content item. Some pixels may be determined to be occluded by the content item, and those pixel values may be modified to depict a portion of a texture the content model rather than to depict a portion of the scene captured by a camera. Some un-occluded pixel values may be modified based on a lighting model. For example, some embodiments may determine as a virtual shadow cast by a 3D model of an AR content item based on a lighting model, where the lighting model may determine a relationship between a light source and a 3D model to determine a size or shape of a shadow boundary on a plane underlying the 3D model. Furthermore, it should be understood that occlusion operations do not stop an object from being represented in a virtual representation of a real-world environment stored in computer memory, and that the partial or total occlusion a model should not be interpreted as preventing the model from being overlaid on a presentation of a real-world environment. In some embodiments, a lighting model may also be used to compute a color and intensity of pixels that are determined to be occluded by the 3D content model. This process may be repeated for each frame of a video feed being captured by camera.

In some embodiments, a presented AR content item, like a 2D view of a 3D model, may be rendered based at least in part on a pose vector of a mobile computing device or camera of the mobile computing device. For example, a 2D view of a 3D model may be placed in a virtual representation of a real-world location within a given frame by an input provided to a computing device. A placed location of the 3D model may be tracked relative to one or more selected nearby points, an anchor position, or a plurality of anchor positions. For example, the placed location may be determined using a RANSAC method based on a plurality of anchor positions or other detected visual features. An AR engine may then determine a new location for the 3D model based on a change in position of the points between successive frames as indicated by a pose vector. For example, an AR engine may compare points in a frame relative to those in the next frame to determine how to render a 3D model for each of the frames. Furthermore, in some embodiments, one or more item properties of an AR content template may be restricted to be within a range. For example, a scaling factor of an AR item may be restricted to be within a permitted range based on a screen limitation of the AR content template. Restricting a scaling factor within a range may prevent the AR content item from being presented on a visual display as being larger than a maximum size or being smaller than a minimum size.

In some embodiments, a computing device may use an AR engine to present a 2D view of a 3D model responsive to a change in position and orientation as indicated by a pose vector, such as by computing a new position and orientation for the 3D model and rendering the view using the AR engine. For example, a 2D view may be scaled and move as if it were physically within the environment. In some embodiments, light effects may be computed from the frames, such as by analyzing the frames for differences in contrast in relation to detected corners to determine a light source intensity, a light source position, or a light source orientation. Such values may be used to apply light effects when rendering a 3D model for a more realistic integration with the environment. In some embodiments, applying light effects includes determining a shadow of the 3D model and shadow boundaries, where the boundaries may include an extension of the shadow beyond of the bounds of the 3D model. As disclosed above, shadow boundaries may specify areas of pixels outside the 3D model to be modified for contrast, such as by darkening the pixels within the shadow boundary. In some embodiments, a 3D model need not be solid, and transparency may be implemented in a similar fashion, but pixels may be lightened or darkened within the boundary.

In some embodiments, an AR content script of the AR content template may be used to determine a movement function of a content item or a set of content items. For example, the AR content script may determine how quickly a content item is presented in response to user positioning or repositioning the content item within an environment or other interaction like a selection of the content item. In some embodiments, an AR content script may specify one or more UI elements to present within a UI in association with a content item or a set of content items. The AR content script may cause the generation and presentation of different sets of the UI elements, such as when a set of content items is presented, positioned, repositioned, or otherwise selected. In some embodiments, an AR content script may request external values via an API to configure UI elements or request UI elements via an API to present UI elements populated with real-time or current-upon-request content. For example, a UI element may be linked to an API configured to provide live inventory information such as item availability, a physical item status, a price, or the like. Further, a UI element may be linked to a payment processing system for effecting a transaction for a physical item corresponding to an AR content item having the configured properties. For example, a UI element like a button may be used to generate an order for the purchase of a physical item having a shape, color, or size of an AR content item.

In some embodiments, the process 200 may include applying analytics based on interactions with the AR content of the AR content template(s), as indicated for block 240. In some embodiments, a computing device may send feedback to an AR platform server that includes analytics capabilities. The feedback may include information such as identifiers of a set of AR content items that had been interacted with, properties of the set of AR content items, durations associated with different interactions or selections, which UI elements associated with the content item were interacted with, and the like. In some embodiments, an AR engine or other components of an AR platform sent to a computing device may be configured to track interactions with AR content items and send feedback about those interactions to an AR platform server. The AR platform server may process the feedback to track user engagement with AR content items based on the sent feedback. For example, the AR platform server may generate a report or value indicating which AR content items are most popular, which item properties of an AR content item are most popular, or general patterns of behavior associated with AR content item interactions. For example, the AR platform server may determine the frequency by which a specific content item was viewed and then closed without transactional interactions (e.g., no purchase order was made for the content item). In some embodiments, the AR platform server may generate heat maps based on frequencies of interactions with a set of AR content items, frequencies of specific interaction types with the set of AR content items, frequencies of interactions with associated UI elements of the set of AR content items, or the like.

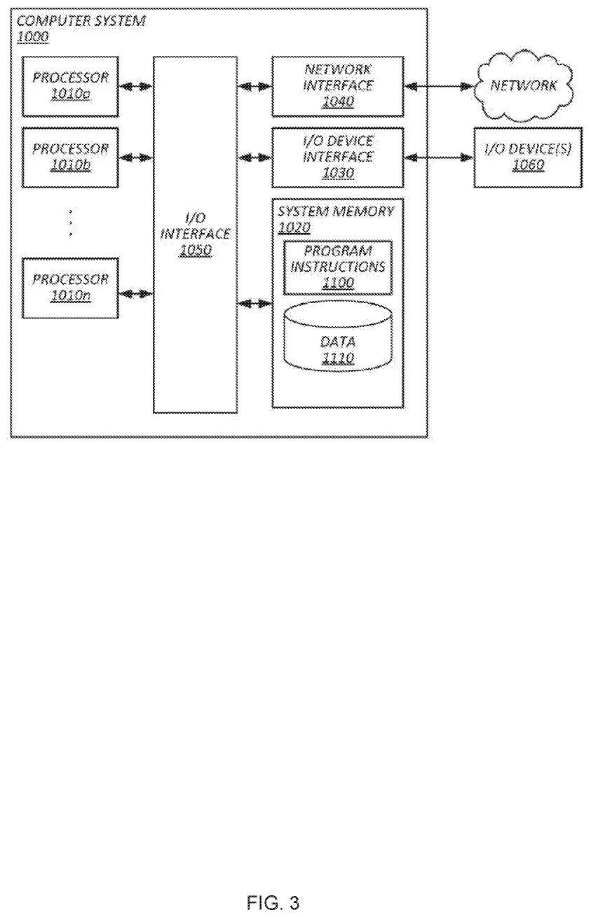

FIG. 3 is a diagram that illustrates an example computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000. For example, the computing system 1000, components thereof, or a collection of computing systems, may be operable to perform one or more operations and/or included in one or more entities to perform those functions. For example, computing systems like computing system 1000 may be utilized to store and process data like that described herein and may be organized in an architecture like that illustrated in FIG. 1. Thus, one or more computing systems 1000 may be utilized to perform operations for configuring components of an AR platform for computing devices, providing the components of the AR platform to computing devices, configuring AR content, serving AR content to computing devices, and analyzing interactions with AR content. Further, one or more computing systems 1000 may be used to perform operations for requesting an AR engine, AR content, or other component of an AR platform and executing a set of received program instructions of an AR platform configured to request and display AR content within a native application, and the like, using techniques disclosed herein. Example elements of an example computing system are discussed in greater detail below.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computing system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computing system 1000 through a wired or wireless connection. I/O devices 1060 may be connected to computing system 1000 from a remote location. I/O devices 1060 located on remote computer system, for example, may be connected to computing system 1000 via a network and network interface 1040.

Network interface 1040 may include a network adapter that provides for connection of computing system 1000 to a network. Network interface 1040 may facilitate data exchange between computing system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1000 or multiple computing systems 1000 configured to host different portions or instances of embodiments. Multiple computing systems 1000 may provide for parallel or sequential processing/execution of one or more portions of the techniques described herein.

Those skilled in the art will appreciate that computing system 1000 is merely illustrative and is not intended to limit the scope of the techniques described herein. Computing system 1000 may include any combination of devices or software that may perform or otherwise provide for the performance of the techniques described herein. For example, computing system 1000 may include or be a combination of a cloud-computing system, a datacenter, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1000 may also be connected to other devices that are not illustrated, or may operate as a stand-alone system. In addition, the functionality provided by the illustrated components may In some embodiments, be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1000 may be transmitted to computing system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party CDNs may host some or all of the information conveyed over networks, in which case, to the extent information (e.g., content) is said to be supplied or otherwise provided, the information may provided by sending instructions to retrieve that information from a CDN.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and embodiments of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all embodiments of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various embodiments of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A tangible, non-transitory, machine-readable medium storing instructions that, when executed by a computing system, effectuate operations comprising: obtaining, with one or more processors, a set of runtime environment properties of a client computing device; selecting, with one or more processors, a set of software libraries of the client computing device for use by an augmented reality (AR) engine based on the set of runtime environment properties, wherein the AR engine comprises a set of binary encodings of a set of bytecode, and wherein the AR engine is executable within an execution environment of a web browser of the client computing device; obtaining, with one or more processors, a request comprising an identifier of an AR content template; and determining, with one or more processors, a response comprising a three-dimensional model, the model being part of the AR content template, wherein the AR engine, when executed within the execution environment of the web browser, causes the client computing device to perform operations comprising: obtain an image of a real-world environment from on an image sensor of the client computing device; obtain a virtual representation of the real-world environment by calling functions of the set of software libraries, wherein the virtual representation comprises a depth map of features in the real-world environment, and wherein the depth map of features comprises an anchor position; render the three-dimensional model overlaid on a presentation of the real-world environment on a visual display using the AR engine and the virtual representation; detect a change in a pose of the image sensor with respect to the anchor position of the virtual representation of the real-world environment, wherein a position in the virtual representation of the real-world environment of the three-dimensional model is determined based on the anchor position; and update the three-dimensional model on the visual display using the AR engine and the set of software libraries based on the change in the pose of the image sensor.
2. The medium of embodiment 1, wherein the set of bytecode is a first set of bytecode, and wherein the set of binary encodings is a first set of binary encodings of the first set of bytecode, and wherein the operations further comprise: receiving, at a server system comprising the one or more processors, a first request from the web browser, wherein a stack-based virtual machine is executable within the execution environment of the web browser; providing the AR engine to the web browser via a response to the first request, wherein the first set of binary encodings comprises a set of opcodes of the stack-based virtual machine, and wherein the set of opcodes is determined based on the set of runtime environment properties, and wherein the stack-based virtual machine comprises a set of computer program instructions based on the set of opcodes; selecting the AR content template by interrogating a database based on the identifier; and providing a second set of binary encodings of a second set of bytecode to the client computing device, wherein: causing the client computing device to render the three-dimensional model comprises causing the client computing device to render the three-dimensional model using the second set of binary encodings; and the second set of binary encodings is associated with the AR content template.
3. The medium of any of embodiments 1 to 2, wherein the set of bytecode is a first set of bytecode, and wherein the set of binary encodings is a first set of binary encodings of the first set of bytecode, and wherein the operations further comprise, and wherein the request is a first request, and wherein the response is a first response, and wherein the operations further comprise: sending a second request from the web browser, wherein the second request indicates a request for a resource, and wherein obtaining the AR engine comprises obtaining the first set of binary encodings in a second response to the second request; obtaining the three-dimensional model of the AR content template via the first response to the first request; and obtaining a second set of binary encodings, wherein the second set of binary encodings that indicate a behavior of the three-dimensional model in response to a change in the virtual representation of the real-world environment, wherein the second set of binary encodings is compiled from code of the AR content template.
4. The medium any of embodiments 1 to 3, wherein: the set of runtime environment properties comprises a property correlated with an available memory of the client computing device; the AR engine further comprises program instructions that cause the client computing device to determine a memory consumption constraint based on the property correlated with the available memory of the client computing device; and the set of binary encodings causes the client computing device to allocate an amount of memory to be used by the AR engine based on the memory consumption constraint when executed by the client computing device.
5. The medium of any of embodiments 1 to 4, wherein: the set of runtime environment properties comprises a property indicating characteristics of a plurality of cameras of the client computing device; the AR engine further comprises program instructions that cause the client computing device to determine an array of cameras corresponding to the plurality of cameras; and the set of software libraries for use by the AR engine comprises a software library associated with the array of cameras, wherein the software library comprises a function to determine object depth based on images provided by the array of cameras.
6. The medium of any of embodiments 1 to 5, wherein the three-dimensional model is associated with a plurality of files having a same file format, and wherein the plurality of files comprises a first file having a first file size and a second file having a second file size that is greater than the first file size, and wherein the operations further comprise: determining whether the set of runtime environment properties satisfies a file reduction threshold; and selecting the first file of the plurality of files in response to a determination that the set of runtime environment properties satisfy the file reduction threshold, wherein the first file comprises the three-dimensional model of the AR content template.
7. The medium of any of embodiments 1 to 6, wherein determining the AR engine comprises steps for determining the AR engine.
8. The medium of any of embodiments 1 to 7, further the operations comprising: determining whether a local version of the AR engine is stored the client computing device; and providing instructions to the client computing device to execute the local version of the AR engine.
9. The medium of any of embodiments 1 to 8, further comprising compiling a first version of the AR engine to determine a plurality of sets of encodings, wherein determining the AR engine further comprises selecting a first set of binary encodings of the plurality of sets of binary encodings based on the set of runtime environment properties, and wherein the set of binary encodings comprises the first set of binary encodings.
10. The medium of any of embodiments 1 to 9, wherein: the AR content template comprises a script encoding a behavior of the three-dimensional model; the set of encodings comprises a subset of binary encodings based on the script; and the subset of binary encodings causes the client computing device to: present a rendered AR content item; change a texture or scale of the rendered AR content item being presented in response to the change in the pose of the image sensor.
11. The medium of any of embodiments 1 to 10, wherein: the AR content template comprises a script; the set of binary encodings comprises a subset of binary encodings based on the script; and the subset of binary encodings causes the client computing device to present a user interface element based on a value obtained via an application programming interface.
12. The medium of any of embodiments 1 to 11, the operations further comprising: determining a geofence associated with the AR content template; determining a location of the client computing device; determining whether the client computing device is within the geofence based on the location; and in response to a determination that the client computing device is within the geofence, sending the three-dimensional model of the AR content template to the client computing device.
13. The medium of any of embodiments 1 to 12, wherein: the three-dimensional model is a first three-dimensional model; the AR content template further comprises a second three-dimensional model; and an item property associated with the three-dimensional model comprises a value indicating a location of the second three-dimensional model with respect to the first three-dimensional model, wherein obtaining the three-dimensional model comprises obtaining the item property.
14. The medium of any of embodiments 1 to 13, wherein: determining the set of runtime environment properties comprising determining a property indicating that the set of software libraries comprises a set of functions to track four or more degrees of freedom of motion with respect to the client computing device; the set of encodings causes the client computing device to: determine the anchor position in the virtual representation of the real-world environment of the client computing device using a feature detection algorithm; determine a set of vectors by tracking the four or more degrees of freedom with respect to the anchor position; and modify a visual display of the three-dimensional model based on the set of vectors and the anchor position.
15. The medium of any of embodiments 1 to 14, wherein the three-dimensional model is a first three-dimensional model, wherein the operations further comprise: obtaining an initial three-dimensional model of the AR content template, wherein the first three-dimensional model is based on the initial three-dimensional model; obtaining a AR content script associated with the three-dimensional model, wherein the AR content script encodes a parameter used to determine an amount by which a presentation of the three-dimensional model changes in response to a detected change in the real-world environment of the client computing device; and determining the AR content template based on the AR content script and the initial three-dimensional model, wherein the AR content template is identified by the identifier.
16. The medium of any of embodiments 1 to 15, wherein the AR engine is a first version of the AR engine, and wherein the operations further comprise: determining a content delivery network storing a second version of the AR engine, wherein the second version of the AR engine comprises the set of binary encodings; and providing program instructions to the content delivery network or the client computing device, wherein the program instructions causes the content delivery network to send the set of binary encodings to the client computing device.
17. The medium of any of embodiments 1 to 16, wherein the set of runtime environment properties comprises a property indicating an operating system of the client computing device, and wherein the operations further comprise: selecting a file format from a plurality of file formats based on the property; and obtaining a file having the file format.
18. The medium of any of embodiments 1 to 17, wherein the set of runtime environment properties indicates that the client computing device comprises an application-specific integrated circuit or a field programmable gate array, and wherein the set of binary encodings causes the client computing device to use the application-specific integrated circuit or the field programmable gate array in response to a determination that the set of runtime environment properties indicates that the client computing device comprises the application-specific integrated circuit or the field programmable gate array.
19. The medium of any of embodiments 1 to 18, wherein the set of binary encodings further causes the client computing device to: determine a first bandwidth of a wireless connection of the client computing device based on the set of runtime environment properties; select a second bandwidth of a plurality of bandwidths based on the first bandwidth satisfying a bandwidth threshold, wherein: the plurality of bandwidths comprises a third bandwidth that is greater than the second bandwidth; and the set of binary encodings to obtain the response comprises program instructions to cause the client computing device to download the response at the second bandwidth.
20. A method comprising: the operations of any one of the embodiments 1-19.
21. A system comprising a set of processors; and a memory storing instructions that when executed by the set of processors causes the set of processors to effectuate operations comprising the operations of any one of the embodiments 1-19.

What is claimed is:

1. A tangible, non-transitory, machine-readable medium storing instructions that, when executed by one or more processors, effectuate operations comprising:
obtaining, with one or more processors, a set of runtime environment properties of a client computing device;
selecting, with one or more processors, a set of software libraries of the client computing device for use by an augmented reality (AR) engine based on the set of runtime environment properties, wherein the AR engine comprises a set of binary encodings of a set of bytecode, and wherein the AR engine is executable within an execution environment of a web browser of the client computing device;
obtaining, with one or more processors, a request comprising an identifier of an AR content template; and
determining, with one or more processors, a response comprising a three-dimensional model, the model being part of the AR content template, wherein the AR engine, when executed within the execution environment of the web browser, causes the client computing device to perform operations comprising:
obtain an image of a real-world environment from on an image sensor of the client computing device;
obtain a virtual representation of the real-world environment by calling functions of the set of software libraries, wherein the virtual representation comprises a depth map of features in the real-world environment, and wherein the depth map of features comprises an anchor position;
render the three-dimensional model overlaid on a presentation of the real-world environment on a visual display using the AR engine and the virtual representation;
detect a change in a pose of the image sensor with respect to the anchor position of the virtual representation of the real-world environment, wherein a position in the virtual representation of the real-world environment of the three-dimensional model is determined based on the anchor position; and
update the three-dimensional model on the visual display using the AR engine and the set of software libraries based on the change in the pose of the image sensor.

2. The medium of claim 1, wherein the set of bytecode is a first set of bytecode, and wherein the set of binary encodings is a first set of binary encodings of the first set of bytecode, and wherein the operations further comprise:
receiving, at a server system comprising the one or more processors, a first request from the web browser, wherein a stack-based virtual machine is executable within the execution environment of the web browser;
providing the AR engine to the web browser via a response to the first request, wherein the first set of binary encodings comprises a set of opcodes of the stack-based virtual machine, and wherein the set of opcodes is determined based on the set of runtime environment properties, and wherein the stack-based virtual machine comprises a set of computer program instructions based on the set of opcodes;
selecting the AR content template by interrogating a database based on the identifier; and
providing a second set of binary encodings of a second set of bytecode to the client computing device, wherein:
causing the client computing device to render the three-dimensional model comprises causing the client computing device to render the three-dimensional model using the second set of binary encodings; and
the second set of binary encodings is associated with the AR content template.

3. The medium of claim 1, wherein the set of bytecode is a first set of bytecode, and wherein the set of binary encodings is a first set of binary encodings of the first set of bytecode, and wherein the operations further comprise, and wherein the request is a first request, and wherein the response is a first response, and wherein the operations further comprise:
sending a second request from the web browser, wherein the second request indicates a request for a resource, and wherein obtaining the AR engine comprises obtaining the first set of binary encodings in a second response to the second request;
obtaining the three-dimensional model of the AR content template via the first response to the first request;
and obtaining a second set of binary encodings, wherein the second set of binary encodings that indicate a behavior of the three-dimensional model in response to a change in the virtual representation of the real-world environment, wherein the second set of binary encodings is compiled from code of the AR content template.

4. The medium of claim 1, wherein:
the set of runtime environment properties comprises a property correlated with an available memory of the client computing device;
the AR engine further comprises program instructions that cause the client computing device to determine a memory consumption constraint based on the property correlated with the available memory of the client computing device; and
the set of binary encodings causes the client computing device to allocate an amount of memory to be used by the AR engine based on the memory consumption constraint when executed by the client computing device.

5. The medium of claim 1, wherein:
the set of runtime environment properties comprises a property indicating characteristics of a plurality of cameras of the client computing device;
the AR engine further comprises program instructions that cause the client computing device to determine an array of cameras corresponding to the plurality of cameras; and
the set of software libraries for use by the AR engine comprises a software library associated with the array of cameras, wherein the software library comprises a function to determine object depth based on images provided by the array of cameras.

6. The medium of claim 1, wherein the three-dimensional model is associated with a plurality of files having a same file format, and wherein the plurality of files comprises a first file having a first file size and a second file having a second file size that is greater than the first file size, and wherein the operations further comprise:
determining whether the set of runtime environment properties satisfies a file reduction threshold; and
selecting the first file of the plurality of files in response to a determination that the set of runtime environment properties satisfy the file reduction threshold, wherein the first file comprises the three-dimensional model of the AR content template.

7. The medium of claim 1, wherein determining the AR engine comprises steps for determining the AR engine.

8. The medium of claim 1, further the operations comprising:
determining whether a local version of the AR engine is stored the client computing device; and
providing instructions to the client computing device to execute the local version of the AR engine.

9. The medium of claim 1, further comprising compiling a first version of the AR engine to determine a plurality of sets of encodings, wherein determining the AR engine further comprises selecting a first set of binary encodings of the plurality of sets of binary encodings based on the set of runtime environment properties, and wherein the set of binary encodings comprises the first set of binary encodings.

10. The medium of claim 1, wherein:
the AR content template comprises a script encoding a behavior of the three-dimensional model;
the set of encodings comprises a subset of binary encodings based on the script; and
the subset of binary encodings causes the client computing device to:
present a rendered AR content item;
change a texture or scale of the rendered AR content item being presented in response to the change in the pose of the image sensor.

11. The medium of claim 1, wherein:
the AR content template comprises a script;
the set of binary encodings comprises a subset of binary encodings based on the script; and
the subset of binary encodings causes the client computing device to present a user interface element based on a value obtained via an application programming interface.

12. The medium of claim 1, the operations further comprising:
determining a geofence associated with the AR content template;
determining a location of the client computing device;
determining whether the client computing device is within the geofence based on the location; and
in response to a determination that the client computing device is within the geofence, sending the three-dimensional model of the AR content template to the client computing device.

13. The medium of claim 1, wherein:
the three-dimensional model is a first three-dimensional model;
the AR content template further comprises a second three-dimensional model; and
an item property associated with the three-dimensional model comprises a value indicating a location of the second three-dimensional model with respect to the first three-dimensional model, wherein obtaining the three-dimensional model comprises obtaining the item property.

14. The medium of claim 1, wherein:
determining the set of runtime environment properties comprising determining a property indicating that the set of software libraries comprises a set of functions to track four or more degrees of freedom of motion with respect to the client computing device;
the set of encodings causes the client computing device to:
determine the anchor position in the virtual representation of the real-world environment of the client computing device using a feature detection algorithm;
determine a set of vectors by tracking the four or more degrees of freedom with respect to the anchor position; and
modify a visual display of the three-dimensional model based on the set of vectors and the anchor position.

15. The medium of claim 1, wherein the three-dimensional model is a first three-dimensional model, wherein the operations further comprise:
obtaining an initial three-dimensional model of the AR content template, wherein the first three-dimensional model is based on the initial three-dimensional model;
obtaining a AR content script associated with the three-dimensional model, wherein the AR content script encodes a parameter used to determine an amount by which a presentation of the three-dimensional model changes in response to a detected change in the real-world environment of the client computing device; and
determining the AR content template based on the AR content script and the initial three-dimensional model, wherein the AR content template is identified by the identifier.

16. The medium of claim 1, wherein the AR engine is a first version of the AR engine, and wherein the operations further comprise:
determining a content delivery network storing a second version of the AR engine, wherein the second version of the AR engine comprises the set of binary encodings; and
providing program instructions to the content delivery network or the client computing device, wherein the program instructions causes the content delivery network to send the set of binary encodings to the client computing device.

17. The medium of claim 1, wherein the set of runtime environment properties comprises a property indicating an operating system of the client computing device, and wherein the operations further comprise:
selecting a file format from a plurality of file formats based on the property; and
obtaining a file having the file format.

18. The medium of claim 1, wherein the set of runtime environment properties indicates that the client computing device comprises an application-specific integrated circuit or a field programmable gate array, and wherein the set of binary encodings causes the client computing device to use the application-specific integrated circuit or the field programmable gate array in response to a determination that the set of runtime environment properties indicates that the client computing device comprises the application-specific integrated circuit or the field programmable gate array.

19. The medium of claim 1, wherein the set of binary encodings further causes the client computing device to:
determine a first bandwidth of a wireless connection of the client computing device based on the set of runtime environment properties;
select a second bandwidth of a plurality of bandwidths based on the first bandwidth satisfying a bandwidth threshold, wherein:
the plurality of bandwidths comprises a third bandwidth that is greater than the second bandwidth; and
the set of binary encodings to obtain the response comprises program instructions to cause the client computing device to download the response at the second bandwidth.

20. A method comprising:
obtaining, with one or more processors, a set of runtime environment properties of a client computing device;
selecting, with one or more processors, a set of software libraries of the client computing device for use by an augmented reality (AR) engine based on the set of runtime environment properties, wherein the AR engine comprises a set of binary encodings of a set of bytecode, and wherein the AR engine is executable within an execution environment of a web browser of the client computing device;
obtaining, with one or more processors, a request comprising an identifier of an AR content template; and
determining, with one or more processors, a response comprising a three-dimensional model, the model being part of the AR content template, wherein the AR engine, when executed within the execution environment of the web browser, causes the client computing device to perform operations comprising:
obtain an image of a real-world environment from on an image sensor of the client computing device;
obtain a virtual representation of the real-world environment by calling functions of the set of software libraries, wherein the virtual representation comprises a depth map of features in the real-world environment, and wherein the depth map of features comprises an anchor position;
render the three-dimensional model overlaid on a presentation of the real-world environment on a visual display using the AR engine and the virtual representation;
detect a change in a pose of the image sensor with respect to the anchor position of the virtual representation of the real-world environment, wherein a position in the virtual representation of the real-world environment of the three-dimensional model is determined based on the anchor position; and
update the three-dimensional model on the visual display using the AR engine and the set of software libraries based on the change in the pose of the image sensor.
